(19) United States
(12) Patent Application Publication
(10) Pub. No.: US 2013/0319975 A1
(43) Pub. Date: Dec. 5, 2013

(54) LASER PROCESSING MACHINE WITH AIR CURTAIN STRUCTURE

(71) Applicants: CHE-MIN KUNG, New Taipei City (TW); HSIEH-CHANG LIN, New Taipei City (TW); CHIH-LIN CHEN, New Taipei City (TW)

(72) Inventors: CHE-MIN KUNG, New Taipei City (TW); HSIEH-CHANG LIN, New Taipei City (TW); CHIH-LIN CHEN, New Taipei City (TW)

(21) Appl. No.: 13/484,527

(22) Filed: May 31, 2012

(51) Int. Cl. B23K 35/38

(52) U.S. Cl. 219/74

(57) ABSTRACT

A laser processing machine with an air curtain structure comprises a machine frame, and a working platform, a processing device, and an air curtain device are disposed on the machine frame. The working platform is used for placing a workpiece. The processing device comprises a rail platform on which a laser output device is disposed. The laser output device is movable on the rail platform and can output laser on the workpiece. The air curtain device comprises at least one air inlet conduit provided with at least one air outlet at a location facing the laser output device on the rail platform. After the air curtain device is connected with an air supply device, the supplied air flows into the air curtain device through the air inlet conduit and is blown toward the laser output device from the air outlet to form an air curtain.

### BACKGROUND OF THE INVENTION

1. Field of Invention

The present invention relates to a laser processing machine with an air curtain structural design which can effectively prevent the hot gas, waste gas, dust, and waste chips produced in the processing from affecting the processing device such as a pen set, and can collect the hot gas, waste gas, dust, and waste chips in order to prevent them from getting into the machine.

2. Related Art

The working principle of a common laser processing machine is to guide and focus an outputted laser beam onto a surface of a to-be-engraved object. The focused laser beam is absorbed by the material of the object and the material is vaporized because of the abruptly increased temperature. The surface of the object is therefore depressed and the objective of engraving or cutting is achieved.

Since high quality laser processing machines have been widely used, various types of laser cutting or engraving machines for leather and cloth are introduced into the market because the material can be cut speedily and different shapes can be cut easily. However, a workpiece is easily affected by the heat, waste gas, dust and waste chips produced in laser processing. Especially if the workpiece is made with flammable materials such as leather, cloth or paper with a low ignition point, the workpiece can be burnt and damaged easily because of the heat and waste chips. More seriously, a fire may break out. Therefore, it is emphasized in the industry on how to eliminate the heat and absorb the waste chips.

Furthermore, the spreading directions of the waste gas, dust and waste chips produced in laser processing are difficult to be controlled. This results in the contamination of the processing device such as a pen set, disposed above the to-be-processed workpiece. Therefore, the processing has to be stopped and the processing device has to be disassembled for cleaning after a certain period of usage. It is troublesome and time-consuming.

### SUMMARY OF THE INVENTION

An object of the present invention is to provide a laser processing machine with an air curtain structural design which can effectively prevent the hot gas, waste gas, dust, and waste chips produced in the processing from affecting the processing device such as a pen set, and can collect the hot gas, waste gas, dust, and waste chips in order to prevent them from getting into the machine.

In order to achieve the above-mentioned objectives, the present invention of a laser processing machine with an air curtain structure comprises a machine frame, and a working platform, a processing device and an air curtain device are disposed on the machine frame. The working platform is used for placing a to-be-processed workpiece. The processing device comprises a rail platform, and a laser output device is disposed on the rail platform. The laser output device is movable on the rail platform and can output laser on the workpiece. The air curtain device comprises at least one air inlet conduit, and the air inlet conduit is provided with at least one air outlet at a location thereon pointing toward the laser output device on the rail platform. After an air curtain device is connected with an air supply device, air supplied by the air supply device flow into the air curtain device through the air inlet conduit, and then the air is blown toward the laser output device from the air outlet, so as to form an air curtain.

In implementation, the air curtain device comprises two air inlet conduits respectively disposed near the two sides of the laser output device on the rail platform on the machine frame.

In implementation, the air inlet conduit is a structure capable of adjusting air blowing direction.

The present invention will become more fully understood by reference to the following detailed description thereof when read in conjunction with the attached drawings.

### BRIEF DESCRIPTION OF THE DRAWINGS

FIG. 1 is a perspective view of an air curtain device being used according to an embodiment of the present invention;

FIG. 2 is a side view of the air curtain device being used according to the embodiment of the present invention; and

FIG. 3 is an illustration of a laser processing machine with an air curtain structure in operation according to the embodiment of the present invention.

### DETAILED DESCRIPTION OF THE INVENTION

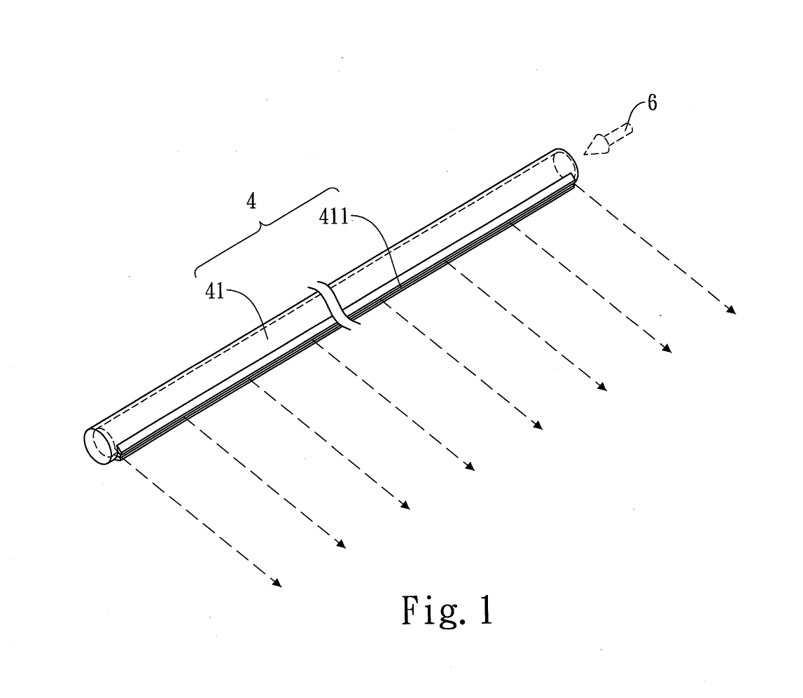

FIGS. 1 to 3 are illustrations of a laser processing machine with an air curtain structure according to an embodiment of the present invention. The laser processing machine with the air curtain structure comprises a machine frame 1. A working platform 2, a processing device 3 and an air curtain device 4 are disposed on the machine frame 1.

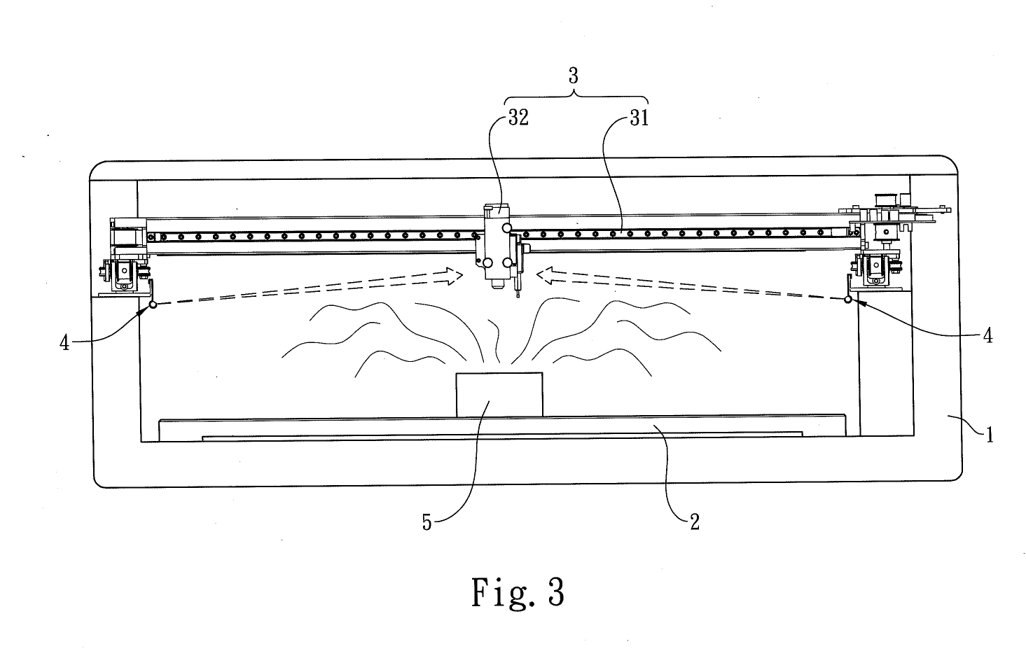

The working platform 2 is used for placing a to-be-processed workpiece 5. The processing device 3 comprises a rail platform 31. A laser output device 32 is disposed on the rail platform 31. The laser output device 32 is movable on the rail platform 31 and can output laser on the workpiece 5. The air curtain device 4 comprises two air inlet conduits 41 disposing by two sides of the laser output device 32 on the rail platform 31 on the machine frame 1 respectively. An air outlet 411 is disposed on each of the air inlet conduits 41 pointing toward the laser output device 32 on the rail platform 31. After the air curtain device 4 is connected with an air supply device (e.g. an air compressor), air 6 supplied by the air supply device flows into the air curtain device 4 through the air inlet conduits 41 and then the air 6 is blown toward the laser output device 32 from the air outlets 411. Thereby, an air curtain is formed as shown in FIG. 3.

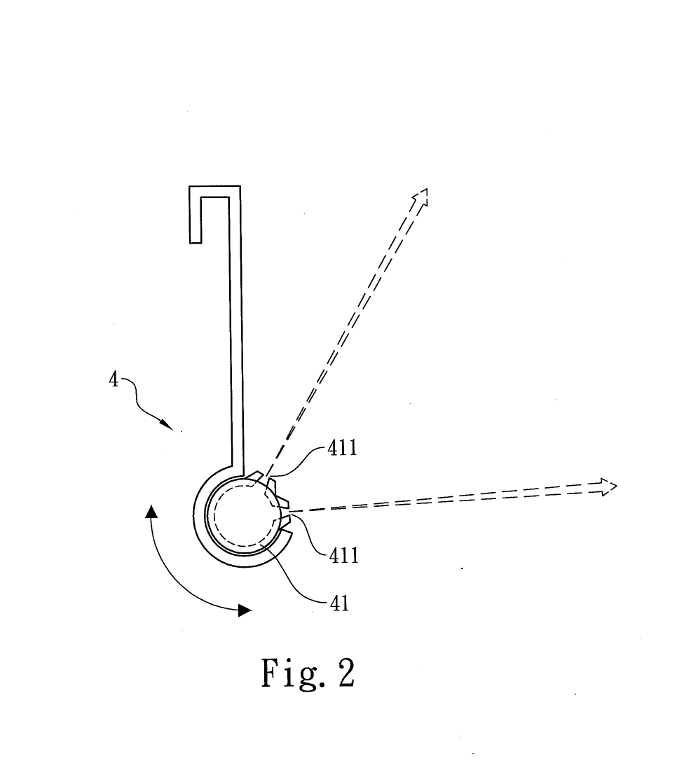

Furthermore, the air inlet conduits 41 are structures which can adjust an air blowing direction as shown in FIG. 2.

When the workpiece 5 is placed on the working platform 2 for processing, the air 6 supplied by the air supply device flows into the air curtain device 4 through the air inlet conduits 41 and the air 6 is blown toward the laser output device 32 from the air outlets 411. Therefore, an air curtain is formed between the laser output device 32 and the working platform 2. Thereby, when the workpiece 5 is processed with engraving or cutting by the laser output device 32, the hot gas, waste gas, dust and waste chips produced in the processing are separated by the air curtain formed between the laser output device 32 and the working platform 2 as shown in FIG. 3. Therefore, the laser output device 32 and other parts of the machine will be prevented from being contaminated, and the hot gas, waste gas, dust, and waste chips are gathered effectively and are collected by a dust collecting device.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A laser processing machine with an air curtain structure, comprising:
a machine frame;
a working platform, disposed on the machine frame for placing a to-be-processed workpiece on top of the working platform;
a processing device, disposed on the machine frame and above the working platform and comprising a rail platform for disposing a laser output device on top of the rail platform, where the laser output device is movable on the rail platform for outputting laser on the workpiece; and
an air curtain device, disposed on the machine frame and comprising at least one air inlet conduit, where the air inlet conduit is provided with at least one air outlet at a location thereon pointing toward the laser output device on the rail platform; after the air curtain device is connected with an air supply device, air supplied by the air supply device flows into the air curtain device through the air inlet conduit and then the air is blown toward the laser output device from the air outlet to form an air curtain.

2. The laser processing machine with the air curtain structure as claimed in claim 1, wherein the air curtain device comprises two air inlet conduits disposed respectively near the two sides of the laser output device on the rail platform on the machine frame.

3. The laser processing machine with the air curtain structure as claimed in claim 1, wherein the air inlet conduit is a structure capable of adjusting air blowing direction.
